(19) United States
(12) Patent Application Publication
(10) Pub. No.: US 2023/0342344 A1
(43) Pub. Date: Oct. 26, 2023

(54) DATA OBJECT SIGNATURES IN DATA DISCOVERY TECHNIQUES

(71) Applicant: Teradata US, Inc., San Diego, CA (US)

(72) Inventors: Paul Brown, Concord, MA (US); Vaikunth Thukral, South San Francisco, CA (US)

(73) Assignee: Teradata US, Inc., San Diego, CA (US)

(21) Appl. No.: 18/149,106

(22) Filed: Dec. 31, 2022

Related U.S. Application Data
(60) Provisional application No. 63/333,753, filed on Apr. 22, 2022.

(51) Int. Cl. G06F 16/21; G06F 16/22; G06F 16/2455

(52) U.S. Cl. CPC G06F 16/213; G06F 16/2255; G06F 16/2456; G06F 16/24565

(57) ABSTRACT

A system may include a storage device configured to persistently store a plurality of data elements. The system may further include a processor in communication with the storage device. The processor may receive a data element. The processor may further identify contents of the data element. The processor may further create a data structure indicative of the contents of the data element. The processor may further store the data structure in the storage device. A method and computer-readable medium are also disclosed.

### CLAIM OF PRIORITY

This application claims the benefit of priority under 35 U.S.C. § 119(e) of U.S. Provisional Patent Application Ser. No. 63/333,753 filed on Apr. 22, 2022, which is hereby incorporated by reference herein in its entirety.

This application is related to co-pending U.S. patent application Ser. No. XX/XXX,XXX entitled “SEMANTIC DATA MAPPING” filed on Dec. 31, 2022.

### BACKGROUND

As the nature of traditional challenges of building enterprise-caliber decision support systems analytic applications evolves and the nature of the data that modern enterprises rely on to make business decisions changes, new techniques in information integration are vital. To exploit the increasingly varied data available to analysts within the modern enterprise, new tools and methods for supporting information integration are necessary. Historically, developers responsible for building decision support systems combined data from multiple independent operational applications or online transaction processing (OLTP) systems, each of which relied on a SQL Database for data management. Each of these applications was typically built on its own SQL schema organizing data into tables with typed columns, subject to declared constraints, and frequently associated with detailed semantic metadata. Yet despite the fact that so much information was available from each data source, integrating data from multiple sources has always been a major, highly labor-intensive challenge because the task has required a detailed examination of hundreds of tables and thousands of columns. Consequently, “best practice” when building decision support data warehouses has traditionally been to concentrate on identifying those portions of the source data that could be made relevant to a target decision support application whose SQL schema and its semantics were known a priori.

Modern approaches to decision support within the enterprise are generating additional requirements. Firstly, modern analytic applications increasingly rely on data from sources that lack the detailed metadata typically associated with traditional information technology (“IT”) applications. For example, it is increasingly common to combine data from automatic monitoring infrastructure (internet of things (“IoT”) streams), machine generated output (e.g., biotechnology) or public data sources (e.g., financial market data or data, published by government agencies), which are all typically published in CSV or JSON formats. Consequently, the challenge of discovering how data within the overall body of data is interrelated, and how to cross-reference data, has emerged as a fundamental requirement. In the absence of any overall documentation or higher-level governance the challenge of information integration frequently, falls to an individual analyst who is given limited guidance.

Secondly, there has been a rise in importance of an approach to data analysis that seeks to combine information in a more speculative manner than has been common in the past. Where previously it was common to rely on designed, industry-specific data models with associated reports generating “Key Performance Indicators”, the increasing trend has been to rely on data analytics to answer a series of varied, impromptu questions. To answer these increasingly ad hoc questions it is necessary first to find relevant data that is included among vast amounts of other data not relevant to the questions. Only once the relevant data has been identified does it become possible to perform some methodologically appropriate analysis on that discovered data. Such ad hoc data discovery is not well supported by traditional methods, especially in situations where thousands or tens of thousands of source data sets are involved.

What traditional approaches to information integration lack is the ability to support search (“Where is data X?”), contextualization (“What other data is related to X?”) and navigation (“How can I get from X to Y?”) within a body of combining heterogenous data about which little is known a priori. Further, it's clear from the very high labor costs associated with manual approaches to this problem that the underlying mechanisms for achieving search and navigate should be as automated as possible. Thus, it is desirable to establish an automated technique to allow data mapping with search and navigation features.

### SUMMARY

According to one aspect of the disclosure, a system may include a storage device configured to persistently store a plurality of data elements. The system may further include a processor in communication with the storage device. The processor may receive a data element. The processor may further identify contents of the data element. The processor may further create a data structure indicative of the contents of the data element. The processor may further store the data structure in the storage device,

According to another aspect of the disclosure, a method may include receiving a data element. The method may further include identifying contents of the data element. The method may further include creating a data structure indicative of the contents of the data element. The method may further include storing the data structure in the storage device.

According to another aspect of the disclosure, a computer-readable medium may be encoded with a plurality of instructions executable by the processor. The plurality of instructions may include instructions to receive a data element. The plurality of instructions may further include instructions to identify contents of the data element. The plurality of instructions may further include instructions to create a data structure indicative of the contents of the data element. The plurality of instructions may further include instructions to store the data structure in the storage device.

### BRIEF DESCRIPTION OF THE DRAWINGS

The present disclosure may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a block diagram of an example of semantic mapping.

FIG. 2 is an operational flow diagram of an example semantic mapping procedure.

FIG. 3 is an operational flow diagram of example identification in a semantic mapping procedure.

FIG. 4 is an operational flow diagram of example ingest in a semantic mapping procedure.

FIG. 5 is an operational flow diagram of example surveying in a semantic mapping procedure.

FIG. 6 is an operational flow diagram of example mapping in a semantic mapping procedure.

FIGS. 7A-7C are operational flow diagrams of an example analyses in a semantic mapping procedure,

FIGS. 8A-8D are an operational flow diagrams of example applications of a semantic map.

FIGS. 9A-9C are operational flow diagrams of example search and navigation of a semantic map.

FIG. 10 is an example of tables used in a semantic mapping, procedure,

FIG. 11 is an example of a signature structure.

FIG. 12 is a block diagram of an example environment capable of implementing a semantic mapping procedure.

### DETAILED DESCRIPTION OF THE FIGURES

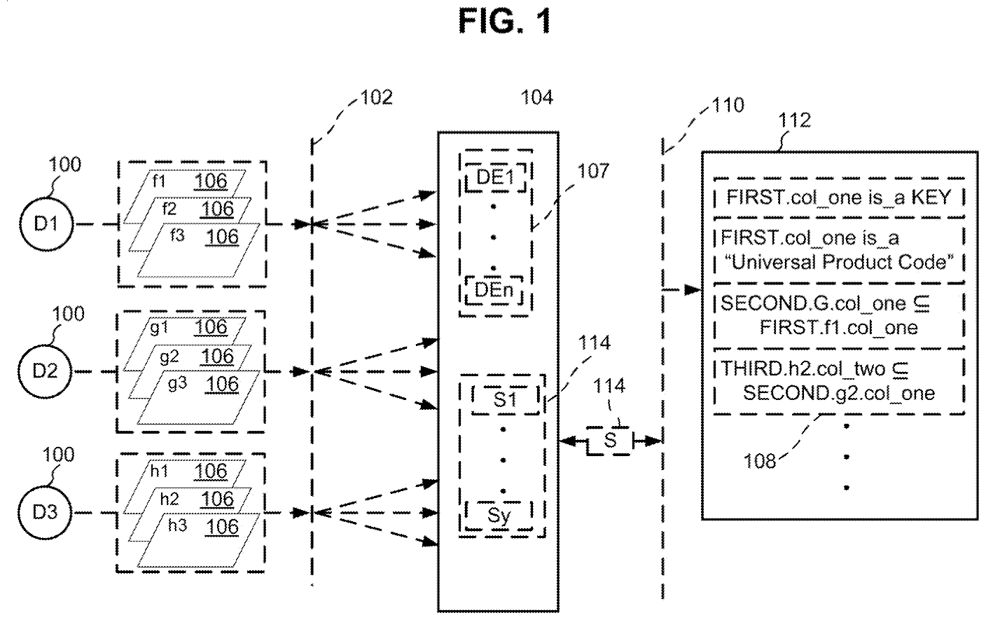

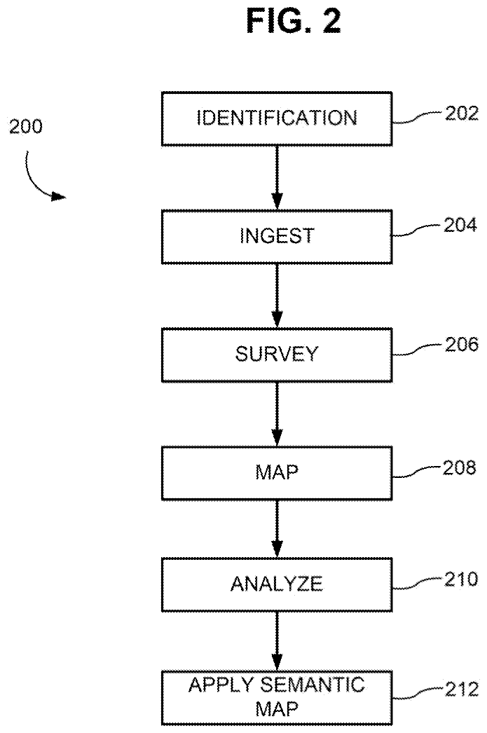

FIG. 1 is a block diagram of overview of the inputs, intermediate data, and outputs, of a semantic mapping procedure. The “raw” inputs to the procedure are a dynamic collection of data sources 100 each of which corresponds to external applications and/or institutional providers of data. In FIG. 1, data sources 100 are individually designated as a DS1, DS2, and DS3. The number of data sources 100 in FIG. 1 is for exemplary purposes and the semantic mapping procedure is not limited to a particular number of data sources. A data source 100 may be the source of a collection of data. For example, a data source 100 may be an online application whose schema and data are subject to an extract-transform-load procedure, an IoT application, an application provided to the enterprise by a third party which provides its results as files in an object store, a named channel in a streaming service, static reference data maintained by some public authority, or data accessed through a distributed data gateway or federated data conduit. The semantic mapping tracks the data sources 100 because they are the ultimate source of data for every rule discovered during semantic mapping (see FIG. 2), which makes the data sources 100 important anchor points for supporting lineage/provenance and auditing. Initially, the semantic mapping procedure involves an ingest stage 102 that brings all of the data from the data sources 100 together into a unified, globally addressable name-space e.g., a logical SQL database, JSON or XML, data store, or a data mesh/data fabric platform that leaves data in place but provides on-demand data access, etc.), which is referred to as a corpus 104. The corpus 104 conceptually represents the storage and organization of all data used for semantic mapping. Practically, the corpus 104 may be one or more systems used for data management, structuring, and analysis, such as data stores and/or analytic platforms.

In FIG. 1, each data source 100 includes a number of data sets 106, individually designated as f1 through f3. A data set 106 may be ingested into the corpus 104 by first having its contents, examined to ensure that its file structure (e.g., CSV, TSV, JSON, XML, etc.) is coherent and consistent, and secondly to create a data structure appropriate tot eh corpus 104 data management platform having an organization—naming labels, data types, etc.—that conforms with what is found in the ingested data set 106. In a SQL environment, each data set 106 may be manipulated to ensure it has a name that is unique within the corpus 104, column names to address the constituent data elements of the data set 106, and column data types (VARCHAR, INTEGER, FLOAT, DATE, ST_GEOMETRY, etc. for SQL, but other languages/structures apply). A data set 106 may be a bundle of data—file, stream, etc.—with a consistent internal format. A single data source 100 generates at least one data set 106. For example, an IoT application might provide a stream of data driven by a sensor on a production line logging objects as they pass and are organized into rows of fixed-width data values, or an official deeds and title records agency might provide a .csv file containing a weekly update of recent real estate transactions. A data source 100 may also generate multiple data sets 106. Typically, the original data in each data set 106 is provided in a some ‘raw’ form (e.g., UTF-8 or ASCII data in a basic .CSV or JSON format).

Data sets 106 contain a number of named columns in a SQL environment. We use the term “element” to refer to the bag of “tokens” or “instance values” that may be addressed by/is associated with a “data set.data_one” address, such as a table column in a SQL table. However, the term “data element” is not limited to SQL environments, but rather, represents an addressable component of a data set 106. In concrete terms, there is a data element 107 associated with the query SELECT “col_one” FROM “FIRST”.“a1”; The term “data element” 107 may be used rather than column because within a semantic map it is more accurate to describe data elements as abstract nodes of a rules graph. It is also useful to make the distinction between table columns and data elements because semantic mapping may be applied to derived data that is the result of some manipulation, such as a function applied to column data using a query.

From a starting point that consists of a unified name pace, one goal of the semantic mapping is to derive a list of rules 108 of the kind shown in FIG. 1. The rules 108 may describe rules regarding data elements 107 of a same data set 10 (e.g., that two data elements are peers within a data set 106) or between data elements 107 of different data sets 106. These rules may apply to single data elements 107 (e.g., when one element 107 of a data set 106 is a “key”), relationships between pairs of data elements 107 (e.g., values of one data element 107 are a subset of another data element 107) or apply to multiple data elements 107 (e.g., when a particular set of values appears multiple times in different data elements 107 within the corpus 104). From a theoretical perspective, these rules 108 are all propositions about the data in the corpus 104 expressed using, set theory and first order predicate logic. For example, we might say that “data element X of data set A functionally determines data element Y of the same data set” or “the data element X of data set A contains data values that are a subset of the data contained in data element Y of data set B.”

Such rules 108 make it possible to search the corpus 104—for example, to find all elements 107 that contain a set of values related to an initial set of search values by some rule 108—to contextualize a particular data set 106—by showing other data sets 106 associated with it through some rules 108—and to navigate between data sets 106—by following a chain of rules 108 possible through additional data sets 106 using data elements 107 with related values as a means of aligning their file structures.

A survey phase 110 may be included in the semantic mapping procedure. During the survey phase 110, a compact representation of the contents of data elements 107 is created, referred to as “signatures” 114, which are, used to summarize the contents of each data element 107 in the corpus 104. Signatures 114 may be stored together with their related meta-data in an analytic/data-store-platform-appropriate schema that constitutes a compressed, specialized identification of the overall corpus 104. As shown in FIG. 1, data elements 107 (individually designated as D1 through Dn where n is the dynamic number of data elements 107) may be stored in the corpus 104 along with their signatures 114 (individually designated as S1 through Sy where y is the dynamic number of signatures 114).

The semantic map 112, which allows both search and navigation to identify data, consists of a body of rules 108, Each rule 108 corresponds to either some property of a data element 107 that a data element 107 is a candidate key for its data set, which means that if a potential value is provided for that data element 107 you should find at most one “row” in the data set), some relationship between two data elements 107 (e.g., when the values in one are a subset of the values in another, or when some measure of statistical similarity exists between the value distribution of the two data elements 107), or some rule 108 about sets of data elements 107 (e.g., when the combination of two data elements 107 in a single data set 106 constitute a “key” even through each data element 107 on its own does not).

The rules 108 that make up the semantic map 112 may be considered a directed graph, with the nodes corresponding to data elements 107 and the rules 108 making up the edges. The simplest rules 108 may be structural. Such rules 108 rely on looking at the way the data set is organized. For example, if the data set is a .csv file then the two data elements in that data set 106 (two different colt Tins in the csv file) are considered “peers”. That is, for every row in the .csv data set there ought to be a value (or a NULL) in each data element 107. If the data set 106 has a hierarchical format, one data element 107 may be considered “dependent” on another because it comes from a lower branch in the hierarchy making it possible to address it relative to the “dominant” data element 107.

Due to the variable quality of raw source data and the approximate methods used, the evidence supporting the existence of these rules is inherently probabilistic. For example, an intuitive rule such as “data element SECOND.g2.col_one is a subset of data element FIRST.f1.col_one” corresponds to the more technically precise “P (x∈FIRST.f1.col_one|x∈SECOND.g2.col_one)>threshold”, and a rule 108 such as “data element FIRST,f1.col_one is a key for data set FIRST.f1” corresponds to the more precise, “The number of values in data element FIRST.f1.col: one divided by the number of rows in data set FIRST.f1 is close to 1.0”. The “threshold” values, which determine the levels at which observed facts about relations between data elements 107 qualify as rules 108, are set via user application based on some examination of the entire semantic map 112 to work with the data in die corpus 104.

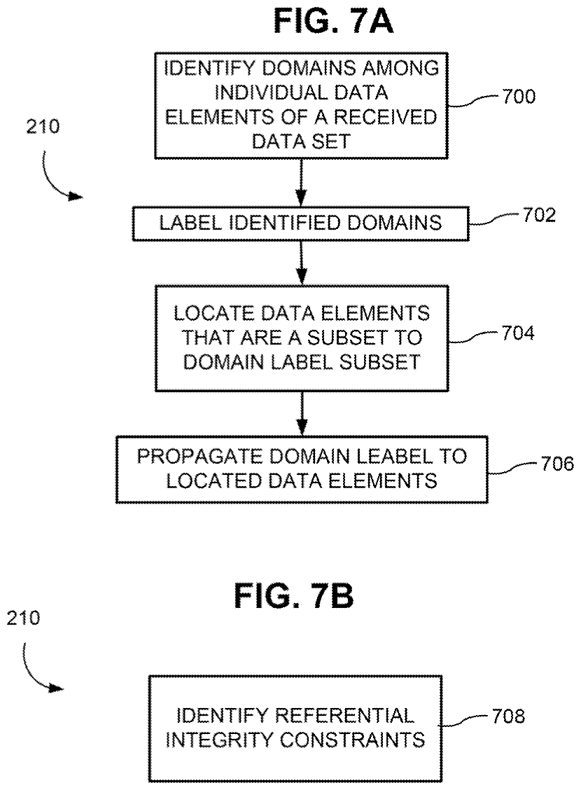

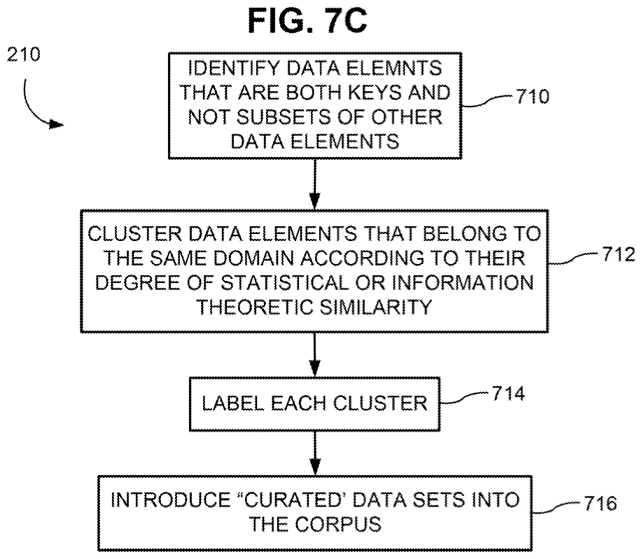

Other rules 108 may be derived from the more basic rules 108 described above. For example, the existence of a domain (see FIG. 7A “FIRST.f1.col_one is a ‘domain.’”) can be inferred from the existence of multiple pairwise rules; “P(x∈FIRST.f1.col_one|x∈ANOTHER.currated.col_upc)>threshold”, and “P(x∈FIRST.f1.col_one|x∈YET_ANOTHER.currated.col_upc)>threshold”, etc. Similarly, a rule 108 such as “SECOND.g2.col_one is a foreign key referencing FIRST.f1.col_one” may be in erred from the rules 108 characterizing “FIRST.f1.col_one is a Key”, and “SECOND.g2.col_one is a subset of FIRST.f1.col_one”. Structural and probabilistic rules 108 can also be combined to produce Functional Dependencies. For example, knowing that “FIRST,f1.col_one as a key”, it follows that “FIRST.f1.col_one determines FIRST.f1.col_two”. Finding basic rules 108, based on the data in data elements 107 and the structure of data sets 108 is the fundamental task of the semantic mapping procedure.

One of the ways rules 108 are used involves automatically “tagging” assigning a descriptive label (or labels) to a data element 107 (see FIG. 7A). For example, following on from the domain rule discovery introduced above, once “FIRST.f1.col_one” is known to be a “domain” (700), user-based-input may supply a domain label (702). This is the first place where semantics (that is, some “labels and meanings”) become a part of the semantic map 112. All such domain labels are the consequence of user-based input; the answer a user may provide when the semantic mapping procedure asks them, “Data that looks like this {v₁, v₂, . . . vₙ} seems to occur frequently in die corpus 104. Can you provide a label?” Domain labels are analogous to a symbols key in a cartographic map. Having labelled such a domain (702), the corpus 104 can be searched to find all data sets 108 that contain an element 107 associated with a domain label. The semantic mapping procedure 200, in isolation, is a mechanism for determining rules such as set theoretic properties of data elements 107 within the corpus 104. But given guidance in the forms of domain labels, or curated data sets, user contribution may be reduced significantly. This approach of tagging large collections of data elements 107 that all comply with some rule is in contrast with other forms of “tagging” where tags are applied to one data element 107 or one data set 106 at a time.

FIG. 2 is an example operational flow diagram of the semantic mapping procedure 200. The data sources and the data sets 106 within them may be initially identified (202). The identification records the relationship between a data. source 100 and the data set 106. The data sets 106 may be ingested (204). During the ingestion, raw data set 106 file(s) are taken in and a query-able interface over the data set 106 is created. in one example, an “auto-schema” functionality to determine a SQL table from a .CSV file may be implemented. In another example, a remote data source such as an operational SQL database might be made accessible using federated or gateway software. The ingestion (204) will make available to the subsequent portions of the semantic mapping procedure an interface that allows access to the set of data values that makes up each data element 107 using a notation such as data_source.data_set.data_element, for example.

Each ingested data set 106 may be surveyed (206). The survey operation (206) may analyze the data in each data element 107 of each new data set 106 (e.g., the columns of the tables in the logical SQL database inferred from the structure of the ‘raw’ data files other than those containing BLOBS or long text) and produce as output one signature 114 for each. Each of these per-data-element signatures 114 may be placed in a repository of survey data, along with the identification (202) metadata that allows navigation back to the location of the underlying data in the corpus 104. That is, back to the data_source.data_set.data_element that was used to extract the data. The survey data repository may a dedicated storage area for survey data such as a SQL database, which may be considered part of the corpus 104 or separate.

After the survey operation (206), the survey data may be mapped (208). With new signatures 114 added to the survey data, the mapping operation 208 involves comparing different signatures 114 to derive the rules 108. A naive approach to this phase would involve comparing each new signature 114 generated by a survey 206 with both every existing signatures 114 from previous surveys 206 and each new signature 114 in this “batch”. Overall, a comparison of the signatures 114 of each data element 107 would need to be made with the signatures 114 of every other data element 107. We reduce that potentially very large number of comparisons by applying heuristics. For example, there may only be comparing of signatures 114 for data elements 107 that have the same logical data type, elements with overlapping ranges of values, elements with similar cardinalities or even similar structural contexts. The survey operation 206 may be made so that either an all-pairs comparison may be made “on demand” or the results of each “batch” of survey comparisons may be stored in a rules data repository.

Once the mapping (208) is complete, the results may be used for analysis (210). In the analysis (202), features of the semantic map may be created. The analysis (210) also allows selective control in order to allow more or less features to be present. Upon completion of the analysis (210), the semantic map 112 may be applied (212), which may include search and navigation features. In one example, the semantic map 112 may be an API whereby users can answer questions along, the lines of “Where in the corpus can I find ‘Universal Product Code’ data?”, “What are the data elements that are functionally dependent on the ‘FIRST.f1.col_one’ key data element?” (note that this last query combines keyness, structural rules, and foreign key rules), or even “What data elements can be associated with “this” one by following the inbound chain of foreign key Rules, key rules, and functional dependencies?”

The operations described in FIG. 2 may proceed independently of one another allowing each operation (202) through (212) to be simultaneously working, on independent portions data. Communication between operations is mediated by the schema that organizes the information repositories. Thus, in one example, separate applications may be used to handle ingest (204), surveying (206), mapping (208), analysis 4210), and application (212).

Moreover, sub-tasks may be parallelized. For example, during the survey (206—which takes as input data from a number of data elements 107, and produces as output to signature for each of them—multiple data elements 107 may be processed concurrently, and when examining a single data large element 107, its data values may be partitioned to survey each partition in parallel, and then merge the per-partition intermediate results into a final signature 114. That is, the data in the FIRST.f1.col_one of FIG. 1 can be partitioned up into multiple blocks of data and the surveying may be performed independently on each of these blocks, and then the per-block results may be merged into a single signature 114 for the entire data element. This allows analytic platforms with parallel-processing capabilities to be utilized effectively with distribution of the various operations of the semantic mapping procedure.

In addition to the inclusion of entirely new data sets 106 and their data elements 107, the semantic mapping procedure may support incremental updates to the corpus 104. That is, data being appended to existing, tables. The surveying (206) of appended data builds on the methods used in parallelism, such as in distributed, parallel processing. The appended data is subjected to a survey operation (206) in isolation, and then the signature 114 produced from this survey operation (206) is merged with the signature 114 associated with the data element 107 being added to. Such a changes may trigger a purge of all the survey and rules data associated with the data elements 107 they contain. This is another procedure that can be accomplished concurrently with the semantic mapping procedure 200.

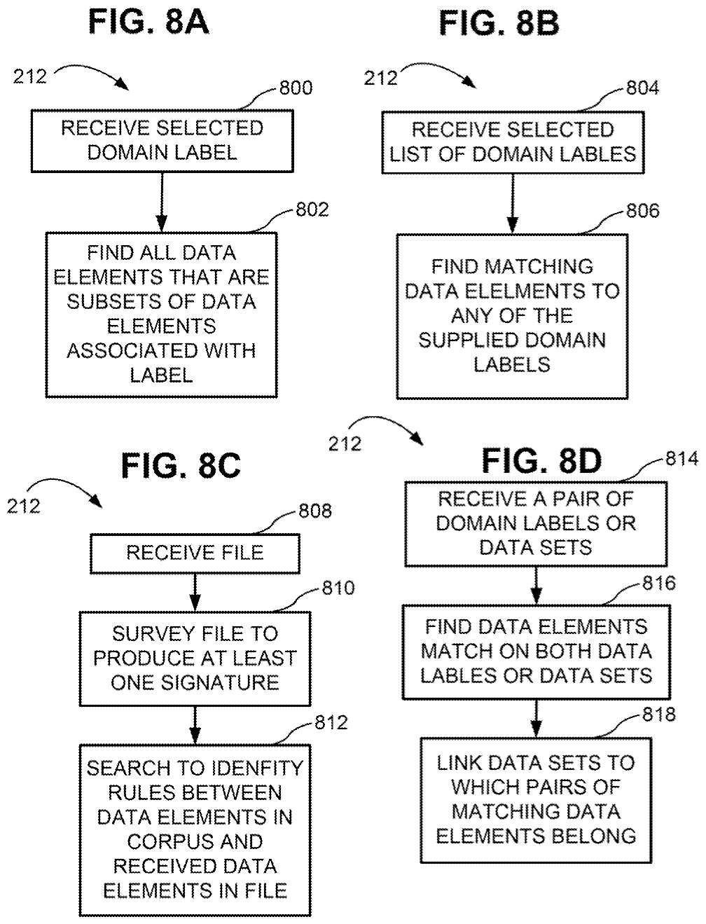

While the description of the of the semantic mapping procedure 200 has been described to this point to limit associations between single data elements 107, it may cater to compounded structures. For example, the semantic map 112 may record that the combination of data elements 107 FOURTH.j2.{column_one, column_three} constitutes a key, and that it participates in a referential integrity constraint with FIFTH.k1. {column_four, column_five} (sec FIGS. 8A-AD). Compound rules may be produced by applying the semantic mapping procedure 200 to data derived from data sets 106 by combining values in a subset of data elements 107 from each data set 106.

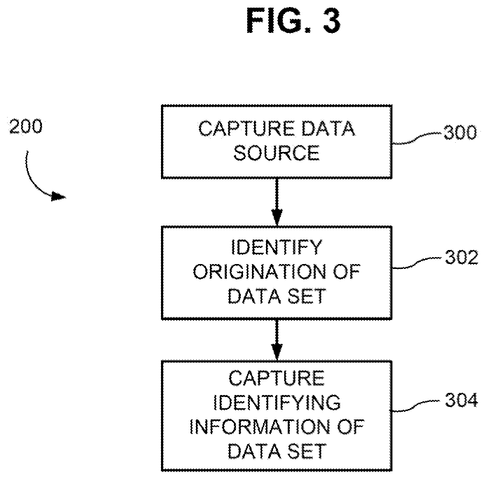

FIG. 3 is an example of an operation flow diagram of an example data set identification operation (300) to be added to the corpus 104. A data source 100 may be captured (300) to identify where a new data set 106 originates (302). The name, label, or other identifying information for the new data set 106 may be captured (304).

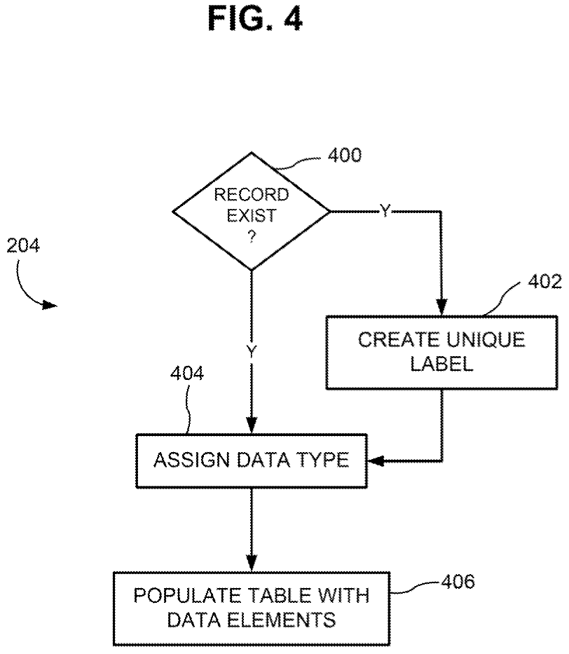

FIG. 4 is an operational flow diagram of an example ingest operation (204). In one example, a determination may be made if a record having the name of a SQL table in SQL environments) created to hold a data set along with the associated identifying information and the data source 100 from which it was derived exists (400). If no name for the data set 106 is available (402), a unique label is created (404). Labels allow the table to be addressed in the corpus 114 for identification. The created table may have a data type assigned to the data elements 107 (406) (e.g., VARCHAR, INTEGER, FLOAT, DATE, ST_GEOMETRY, etc.). The created table may be populated with the data elements 107 from the data set 106 (408).

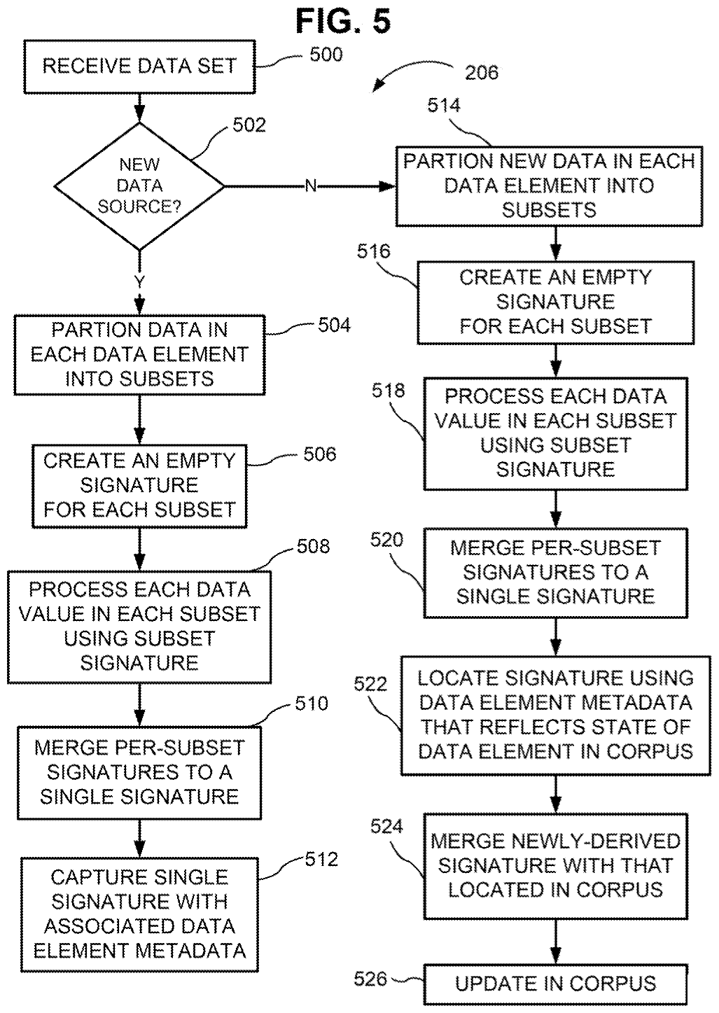

FIG. 5 is an operational flow diagram of a survey procedure (206). In one example, the survey procedure 206 may survey the data sets 106 in the corpus 104 to create a one-per-data element signature 114. In one example of the survey procedure (206), a data set 106 may be received (500). If the data set 106 is new (502), for each data element 107 in a new data set 106, the data in the data element 107 may be partitioned into some number of non-overlapping subsets (504). For each subset, create an empty (NULL) signature (506). For each data value in each data element 107 in each subset, process each value using that subset's signature (508). The per-subset signatures may be merged such that a single signature 114 represents all of the data of the data element 107 (510). The new signature 114 may be captured together with the associated data element metadata (data source, data type, etc.) (512).

If a data set 106 is determined to be from a previously-identified data source (502), for each data element 107 in the data set 106, the new data may be partitioned into a number of non-overlapping subsets (514). For each subset of the data in the data element, create an empty (NULL) signature (516). For each data value in each subset, process the value using that signature 114 of the subset (518). The per-subset signatures may be merged to obtain a single signature 114 that represents all of the data in this data element 107 (520). Using the metadata of the data element 107 (data source, data set, data element name) locate the signature 114 in the survey data that reflects the state of the data element data already held in the corpus 104 (522). The signature 114 derived from the appended data may be merged with the signature 114 derived from the data already loaded (524). The entry in the survey data repository may be updated for the data element 107 (526).

The mapping (208) may record the results of various comparisons between signatures 114 created in the survey (206). The mapping (208) may begin with a list of signatures 114 that are either: (a) the result of a survey (206) completed over newly-added data elements 107; or (b) recently updated/merged following the addition of data to pre-existing data sets 106 in the corpus 104. Mapping (208) may examine individual signatures 114 or compare signatures 114 with other signatures 114.

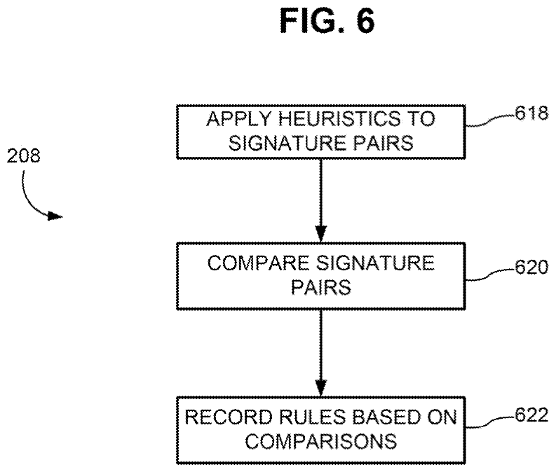

Mapping (208) may be used to create both structural rules and data rules. Structural rules may refer to the structure or organization of raw input data received from data sources 100. The data role may refer to the tokens or instance values associated with structural data element 107. Mapping (208) may involve determining if a single signature 114 is a key or determine relationships between signatures 114. FIG. 6 is an operational flow diagram of an example of the mapping (208) of signatures 114 that implements signature 114 comparisons. A number of heuristics may be applied to the signature 114 (600) in order to reduce the number of comparisons made. Once made, each pair of signatures 114 may be compared (602). For example, a pair of data elements 107 in the survey repository data may be designated as A and B. In one example, a comparison is made between A and B may be made when: 1. A and B data elements have a comparable SQL Data Type (INTEGER, VARCHAR, etc.). “Comparable”, in this context, may refer to compare VARCHAR(12) and VARCHAR(16), or BIGINT and INTEGER, but not (without additional transforms) INTEGER and DATE., 2. the value ranges of the data in A and B data elements overlap. That is, an examination of each data element's 107 minimum and maximum values indicate they could have values in common; 3. The ratio of the cardinalities (that is, the number of distinct values) of A and B data elements are within predetermined range; and 4. Data elements 107 that largely or entirely consist of missing (NULL) values can be ignored. If a comparison of A and B passes the comparisons heuristics, a second comparison (608) is made to determine if a rule 108 is to be created and added to the rule repository. Using the example of A and B data sets, the example comparisons to be made may include: 1. If P(x∈B|x∈A)>a predetermined threshold (e.g., 1.0—estimate error), then record a rule to the effect that “B is a subset of A.”. If P(x∈A|x∈B)>a predetermined threshold then record “A is a subset, of B”; 2. If P(x∈B|x∈A)>a predetermined threshold and P(x∈A|x∈B)>a predetermined (e.g., estimate threshold), then we may record rules to the effect that “B intersects A” and “A intersects B”; and 3. using the statistical and information theoretic measures of distance between the sample distributions of A and B—for example, using a χ² test of independence indicates that the two samples derive from the same “parent” distribution—for example, if two columns of FLOAT values both reflect baseball batting averages, for example,—then we associate them with a rules of the form “A is not independent of B” and “B is not independent of A”. In other examples, additional heuristics may be used with more narrowly focused technical interpretations. For example, precise ranges of latitude and longitude values for a particular country or state, TF/IDF bigram comparisons based on VARCHAR samples, etc.

Examples of the comparisons (604) and rule recordation (606) may include:
1. If P(x∈B|x∈A)>some threshold (e.g., 1.0−estimate error), then record a Rule to the effect that “B is a subset of A”. But if P(x∈A|x∈B)>some threshold then record “A is a subset of B”.
2. If P(x∈B|x∈A)>a lesser threshold (e.g., estimate threshold) and if P(x∈A|x∈B)>the same threshold, then we may record rules to the effect that “B intersects A” and “A intersects B”.
3. Using the statistical (2) or information theoretic measures of divergence (Jensen-Shannon) between the sample distributions of A and B, if the test statistic exceeds some threshold, then record a Rule to the effect that A and B are “not independent”.

The number of signature comparisons (604) in the mapping (208) may be reduced with the use of dynamic programming methods that exploit the transitivity of set theoretic relationships. For example, from the fact that data sets A∈B and for another data element, C for example, it is established that B˜∩C (that is, B and C are disjoint), an inference that A˜⊂C (that is, that A is not a subset of C) and that A˜∩C (that is, A and C are disjoint) can be made eliminating the need to compare the signatures 114 (620) of A and C. These inferences may be exploited by initially only comparing a new data element 107 with others that have no super-sets (that is, so-called dominant sets of values) and afterwards looking only at data elements 107 which are subsets of the dominant set the new data element 107 intersects.

FIG. 7A is an operational flow diagram of an example analysis (210) allowing the rules 112 generated during the mapping (208) to be used in recording features of the corpus 104 in the semantic map 108. In one example, domains may be identified among individual data elements 107 of a received data set 106 (700). In one example, this may be performed for each data element 107. For each data element 107, it may first be determined if there is no other data element 107 that contains a superset of the values in the first. For example, for each data element 107 A, and calling each other data element 107 being checked one at a time B, this may mean comparing, a long list of pairs of data elements {A, B}. When P(x∈B|x∈A)>some threshold 1.0 minus the error in the signature estimators) is found, it may be established that there exists at least one data element 107 (B, in this example) that contains a super-set of the values in A, so A cannot be used to characterize a domain. If also found, however, that P(x∈A |x∈B)>some threshold (e.g., 1.0 minus the error in the signature estimators) then A and B contain the same set of values. Of the set of data elements 107 that satisfy the two conditions above (that is, given a set of clusters of data elements 107 which all contain the same and which lack any other data element 107 that is a strict superset of their values), some third tie-breaking selection criteria may be applied (e.g., the data element 107 with the smallest population, or added earliest to e corpus 100) to select a single the data element 107 within each group of data elements 107 containing the same values.

The data a data element 107 that satisfies these three conditions constitute a domain; which may refer to a set of values that is distinctive from all others (that is, that while the values in this data element 107 might be found in multiple other data elements 107, and while the values in this data element 107 might overlap with others' values, this data element 107 has values which characterize some conceptual point of reference in the rest of the corpus 104. Thus, a domain label is given (702). Once a domain is established, other data elements 107 may be found that are a subset of the one given a domain label (704) and the new domain label may be propagated to them in the corpus 104 (706).

FIG. 7B is another example of the analysis (210) that includes identifying referential integrity constraints among pairs of data elements 107 (708). For example, if a pair of data elements A and B are identified as participating in an inclusion dependency B⊂A (e.g. when P (x∈A|x∈B)>1.0−error estimate), and if A is a KEY for its data set (e.g., when |A|/Population (A)>1.0−error estimate), then it is noted in the rules data repository that this is a special kind of inclusion dependency, specifically a referential integrity constraint. Softer rules may also be recorded when the first criteria (B∉A) holds, but A is not a KEY.

FIG. 7C is another example of the analysis (210) that includes a search for patterns in the created rules and labeled as a result of such identification. Examples of such search and labeling. may include: 1) Identify data elements 107 which are both keys and are not subsets of an other data element 107 (710). Label data elements 107 as a “Strong Key”; 2) Cluster data elements 107 that all belong to the same domain according to their degree of statistical or information theoretic similarity and label each cluster (712); 3) introduce “curated” data sets 107 into the corpus 114 (714)(a “curated” data set 107 is one whose semantics are known a priori; for example, a canonical list of all “Universal Product Codes” or “Federal Information Processing System” codes, and use it to identify specific kinds of data in the corpus 104.

Once the semantic map 112 is created, the corpus 104 may be searched and navigated through in order to efficiently locate particular data using the semantic map 112. FIGS. 8A-8D are operational flow diagrams of example application (212) allowing search and navigation features available for the semantic map 112. There may be multiple manners in which to search the corpus 104. In one example of FIG. 8A, a search may begin with receiving a selected domain label (800) and finding all of the data elements 107 in the corpus 114 that are subsets of the data element(s) 107 associated with that label (802). For example, all data elements 107 may be located that are associated with the label “Universal Product Codes”, and then all of data elements 107 which contain soave subset of the data in the labeled data elements 107 may be located.

FIG. 8B is an operational flow diagram of the application (212) for another example search. The search may include receiving a list or domain labels (804), and finding, with the received information, in the rules data repository the data sets 106 (806) which includes data elements 107 that match (in the same manner as described in FIG. 8A) with any of the supplied domain labels. For example, searching for “Universal Product Code”, and “Zip codes” will locate data sets 106 in the corpus 104 which have two data elements 107 associated with the received domain labels.

FIG. 8C is an operational flow diagram of the application (212) for another example search. The search may include receiving a file (808). Data elements 107 in the file may be surveyed (206) to produce at least one signature 114 (810). Based on the derived signature(s) 114, the survey data repository may be searched using the mapping techniques of FIGS, 6A and 6B to identify map rules 112 between data elements 107 in the corpus 104 and data elements 107 in the file (812). The result of this search is a list of data sets 106 in the corpus 104 that share rules with the data in the file.

FIG. 8D is an operational flow diagram of the application (212) for another example search, which allows expansion of the range of the search using domain labels or an example data set to span multiple data sets 106. For example, the search may receive a pair of domain labels or example data sets 106 (e.g., A and B) (814). All data elements 107 may be found in the corpus 104 that “match” on A or 8) (816). The search may include using the data in the rules data repository to link the data sets 106 to which pairs of matching data elements 107 belong (818). For example, starting a search with “Universal Product Code” and “Zip code” might find entries in two data sets 106 linked via a referential integrity constraint or alternatively an inclusion dependency.

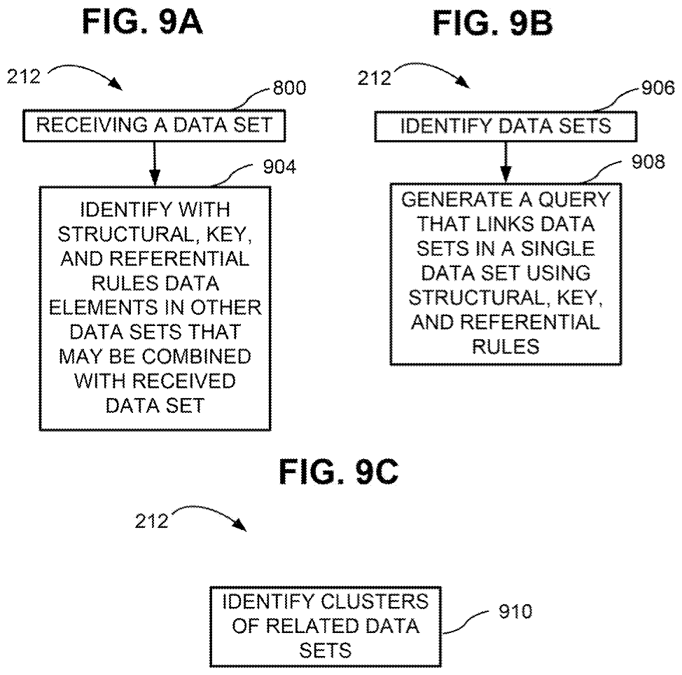

FIGS. 9A-9C provide examples of that application (212) allowing navigation through the corpus 104 using features of the semantic map 112. FIG. 9A is an operational flow diagram of the application (212) for an example navigation. The navigation (900) may include receiving a data set 106 identified by either a search, such as those described in FIGS. 8A-8D or by using metadata acquired during the ingest (204) (900). The navigation may include using a combination of the structural, key and referential rules to determine which data elements 107 in other data sets 106 can be combined with the data in the initial one (902). Combinations in this context may be achieved with joins that “denormalize” the two data sets.

FIG. 9B is an operational flow diagram of the application (212) for another example navigation that includes discovering how to link two data sets 106. The two “anchor” data sets 106, A and B for example, might be identified using the methods described in FIGS. 8A-8D (906). Structural, key and referential rules may be combined to allow generation of a query that “links” the two into a single data set 106 (908).

FIG. 9C is an operational flow diagram the application (212) of another example navigation that it dudes analyzing the overall semantic map rules 108 to identify clusters of related data sets 106 (910). For example, when a number of data sets 106 from a single data source 100 all share some Common problem domain, with a set of unifying strong keys (such as a list of the “Universal Product Codes” an entity sells, the account numbers it associated with its customers, and so on), within a single corpus 104 there may be many such clusters of related data sets and the contents of the rules data repository can help distinguish among them.

In the description above, the use of a repository to hold signature 114 data (along with rules 108) is referenced. In one example, a schema to used may organize and record: 1) Storing signature 114 data and recording the relationships between each signature 114 and the data element 107 from which it was constructed; 2) Managing the provenance (history) of this relationship. That is, enough information need retained to he able to support incremental changes to data in the corpus 104; 3) Storing rules data that characterizes the relationships between data elements 107; 4) Information to manage the provenance (history) of these rules; and 5) SQL views over the basic repository that provide semantic information to analytic users. These. views are lists of things like domains, keys, key to foreign key relationships, inclusion dependencies, statistically non-independent data distributions, and so on.

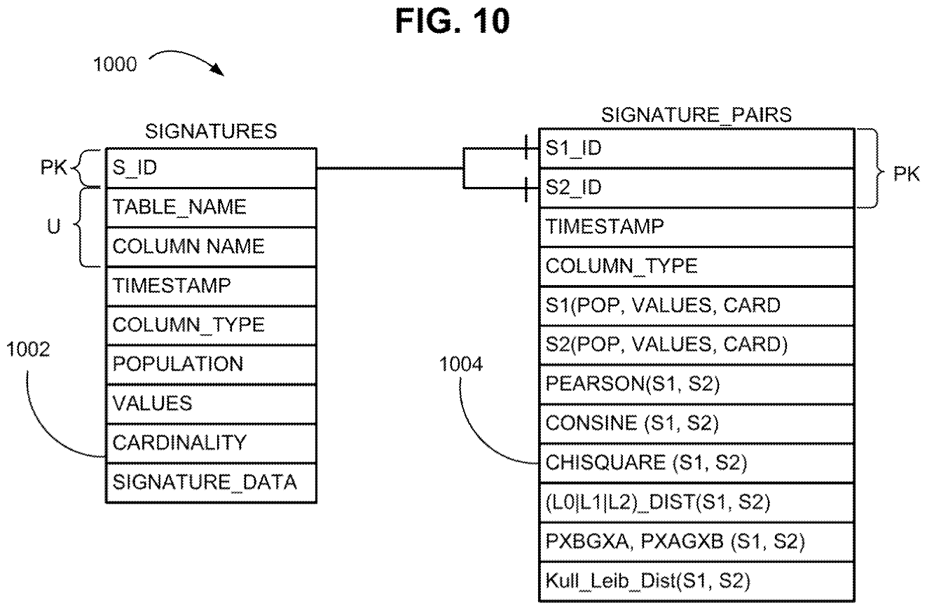

FIG. 10 is an example schema (1000) that may be used for semantic mapping that includes a SIGNATURES table (1002) and a SIGNATURE_PAIR table (1004). Note that, for example, the COLUMN_TYPE, ROW_COUNT, VALUE_COUNT and DISTINCT_COUNT values of the SIGNATURES table 1002 can all be extracted from the SIGNATURES.SIGNATURE_DATA column 1002, and all of the values (e.g., population in the SIGNATURE_PAIRS table 1004 either repeats information from the SIGNATURES table 1002 or else may be calculated by comparing the SIGNATURE_DATA table 1004 entries from the corresponding entries in the SIGNATURES table 1002 with user-defined functions. The decision about what t materialize and what to calculate is a physical tuning question beyond the scope of this disclosure.

Table 1 below describes the correspondence between elements of the schema in FIG. 10, and components of the semantic mapping procedure (200).

TABLE 1
Columns of the SIGNATURES Table in the Semantic Mapping Repository Schema

| Schema Element | Relationship to Semantic Mapping Procedure |
|---|---|
| S_ID | None. This is simply a surrogate key meant to clarify the |
| | relationship between the SIGNATURES table 1002 and the |
| | SIGNATURE_PAIRS table 1004. |
| DATA_SOURCE | Identity of the data source 100 from which the data set 106 and the |
| | individual data element 107 was ingested. |
| DATA_SET_NAME | Name of the data set 106 in the corpus 104 that contains the data |
| | element 107 from which the procedure derives the |
| | SIGNATURE_DATA table 1002 entries. |
| DATA_ELEMENT_NAME | Name of the data element 107 within the data set 106 from which |
| | the procedure derives data from the SIGNATURE_DATA table |
| | 1002. Note that the combination of TABLE_NAME and |
| | COLUMN_NAME constitute a candidate key for the |
| | SIGNATURES table 1002. The information in these columns may |
| | be used to cross reference signatures 114 with the contents of the |
| | corpus 104. |
| TIMESTAMP | Date and time (or version number) at which the semantic mapping |
| | procedure analyzed (200) the data element 107 in the corpus 104 to |
| | produce and store entries in the SIGNATURE_DATA table 1002. |
| | This column's information provides the basis for the provenance or |
| | history of this analysis. In more elaborate schemas a more complete |
| | history would need to be stored. Captured (recorded) in Steps 1 and |
| | 2. |
| COLUMN_TYPE | Data type of the data element. Captured during the ingest procedure |
| | (204). |
| POPULATION | Number of rows in the data set 107. This data is added or updated |
| | during the survey operation (206). |
| VALUES | Number of non-NULL (e.g., not “missing”) values in the data |
| | element. This will always be less than or equal to the number in the |
| | associated POPULATION column. This data is added or updated |
| | during the survey (206). |
| CARDINALITY | The number of distinct values in the data element 107. This will |
| | always be less than or equal to the number in the associated |
| | VALUES column. This data is added or updated during the survey |
| | (206). |
| SIGNATURE_DATA | The result of the survey (206). This will be a data object (e.g., user- |
| | defined type) created by the survey (206) (or possibly during ingest |
| | (204)). The contents of these data objects can be interrogated to |
| | make determinations such as that of the previous three values in |
| | Table 1 or compared (the compare phase of the procedure) to |
| | populate columns in the SIGNATURE_PAIRS table 1004. This |
| | data is added or updated during the survey (206) and used during |
| | the mapping (208) to derive rules about the corpus (104) |

The SIGNATURES table 1002 may be populated during the ingest operation (204) once a data source 100 has been identified. As data is examined during the ingest operation (204), each data element 107 can be surveyed with the survey operation (206), a process that can be performed in parallel (for scalability) and within the same software platform where the corpus data, and the semantic mapping repository will be stored. That is, this table may be populated by a single application that combines the ingest (204) and survey (206) procedures of the detailed procedure above. As new data is appended or ingested (204) to the corpus 104, the survey (206) and mapping 208) procedures can use the TIMESTAMP to distinguish new from old data and to determine which rules may need to be checked in the light of new data.

Contents of the SIGNATURES_PAIRS table 1004 are derived during the mapping (208) of the semantic mapping procedure 200. That is, the SIGNATURE_PAIRS table (1004) is populated during mapping (208), with computational majority being clone as part of signature comparison(s) (602), and the features described the analysis (212) being produced using SQL queries or SQL views over these two tables.

What each row in the SIGNATURE_PAIR table 1004 records is that there is some relation between the data values associated with two data elements 107. But the categorical nature of this relationship (e.g., when the values in one data element 107 contains a subset of the values in the other, or when one data element 107 has the same range of values exhibiting the same statistical distribution as the values in the other) is not recorded explicitly. Rather, each row in the SIGNATURE_PAIRS table 1004 records some probabilistic, mathematical or statistical evidence. Any decision about the existence of sonic categorical rules is made by the user when they specify a threshold value during the analyze procedure 210. An important point to make is that getting to the rows in the SIGNATURE PAIR table (1004) is going to involve rejecting the vast bulk of the extremely large number of candidate pairs implied by comparing each signature 114 of a data element 107 with all other signatures 114 of the data elements 107. Efficiently detecting and rejecting highly-improbable candidates is key to the efficiency of the: mapping (208) of the semantic crapping procedure 200. The analysis (210) requires writing queries over this schema to discover things like domains, keys, etc. We present the way keys and key/foreign key relationships are inferred below.

A (single column or single data element 107) key occurs when the cardinality Of the. values in the data element 107 (e.g., the number of unique values) approaches the population of its data set 106. In other words, a column (of a file or otherwise unconstrained table) is a key when searching that column using a (possible) value Will identify at most one row in the data set. The nature of the data dealt with and features of the process mean. that on a simple inequality to determine when a column is a key cannot be relied upon. The underlying data may be “dirty” (that is, the original data source file can contain a few values which violate the key constraint) or otherwise of poor quality. And the value of the cardinality derived from the Signature object is an estimate, albeit one of known and narrow error bars. Consequently, a calculation some measure of “keyness” is required and a filtering, of candidate data elements 107 that fall below some threshold for this metric.

TABLE 2
Columns of the SIGNATURE_PAIRS Table

| Schema Element | Relationship to Semantic Mapping Procedure |
|---|---|
| S1_ID, S2_ID | Columns that are foreign keys relating the entry in |
| | SIGNATURE_PAIR table with the entry in the SIGNATURES |
| | table. The pair of these columns constitute the key of the |
| | SIGNATURE_PAIR table. |
| TIMESTAMP | Date and time (or version number) at which the semantic mapping |
| | procedure 200 analyzed the pair of signatures 114 and populated |
| | this row. This column is a placeholder for implementing the |
| | provenance (history) functionality required by the overall |
| | semantic mapping procedure 200. |
| COLUMN_TYPE | Data type of both data elements 107 compared to produce this |
| | row. |
| S1 {POP, VALUE, | The POPULATION (row count), VALUE count (count of non- |
| CARD} | null values) and CARDINALITY (count of distinct values) in the |
| | the S1 data element 107. |
| S2 {POP, VALUE, | The POPULATION (row count), VALUE count (count of non- |
| CARD} | null values) and CARDINALITY (count of distinct values) in the |
| | the S2 data element 107. |
| PEARSON, COSINE, | Measures of statistical or information theoretic distances between |
| CHISQUARE, | the values in the pair of data elements 107 S1 and S2. |
| Ln_DIST, | |
| Kull_Lein_Dist | |
| PXAGXB, PXBGXA | Measures of conditional probabilities of values being shared by |
| | the two data elements S1 and S2. These correspond to P (x ∈ S1 \| |
| | x ∈ S2) and P (x ∈ S2 \| x ∈ S1) respectively. |

Below is an example query that performs this filter using the values in the SIGNATURES table (1002). This query implements operation (700).

```
SELECT S.TABLE_NAME AS DATA_SET,
        S.COLUMN_NAME AS DATA_ELEMENT,
        S.CARDINALITY / S.POPULATION AS KEYNESS
    FROM SIGNATURES AS S
  WHERE S.COLUMN_TYPE IN ( ‘INTEGER’, ‘BIGINT’,
  ‘VARCHAR’, ‘DATE’ )
      AND S.CARDINALITY / S.POPULATION > threshold;
```

Another type of constraint rule desired to be discovered is foreign keys, which arises when the values in one data element 107 that has been identified as a key are a super-set of the values found in another data element. We can establish super and subset relationships—which are more formally referred to as inclusion dependencies—by looking at the PXAGAB and. PXBGXA. estimates in the SIGNATURE_PAIRS table (1004), if P(x∈A|x∈B) exceeds some threshold (again, all of these determinations are subject to data quality limitations and estimation errors) foreign key rules may be identified.

```
WITH KEYS ( ID ) AS (
SELECT S.ID AS ID
    FROM SIGNATURES AS S
  WHERE S.COLUMN_TYPE IN ( ‘INTEGER’, ‘BIGINT’,
  ‘VARCHAR’, ‘DATE’ )
      AND S.CARDINALITY / S.POPULATION > keyness_threshold
)
SELECT S1.TABLE_NAME AS KEY_DATA_SET,
          S1.COLUMN_NAME AS KEY_DATA_ELEMENT,
          S2.TABLE_NAME AS FKEY_DATA_SET,
          S2.TABLE_NAME AS FK_DATA_ELEMENT,
          S1.CARDINALITY / S1.POPULATION AS KEYNESS,
  FROM SIGNATURES AS S1 JOIN
            SIGNATURE_PAIRS AS S ON ( S1.ID = S.S1_ID )
            JOIN SIGNATURES AS S2
    WHERE S.COLUMN_TYPE = S1.COLUMN_TYPE
        AND S.COLUMN_TYPE = S2.COLUMN_TYPE
        AND S1.COLUMN_TYPE = S2.COLUMN_TYPE
        AND S1.ID <> S2.ID
        AND S.PXBGXA > keyness_threshhold;
```

Note that the “S.PXBGXA>keyness_threshhold” inequality is only one of a number of filters that can be applied here. We may check that the cardinality estimates of the two data elements 107 are dose (enough), that the range of values overlaps.

With regard to signatures 114, an important point to note at the outset about is that their content may vary depending on the nature of the data in the data element 107 from which they were constructed. For example, it is possible, given the design of the signature 114, to include a complete frequency distribution of the values of a data element, which makes it possible to estimate statistics such as cardinality, or to compare the contents of two data elements 107 for set-theoretic relationships with absolute precision. Once the size of the data required to hold the frequency distribution exceeds some pre-configured threshold (e.g., 48 KB) the data object shifts to a combination of a kind of minHash data structure and a simple random sample. From the combination of these precise estimates of statistics such as cardinality of the data element 107 and properties of the values (mean, variance, statistical distribution) and comparisons between pairs of bags of values (statistical tests, information theoretic distances, other comparison metrics) may be arrived at. The overall goal of the design of a signature data object is to pack as much information about tokens instance values in a data element 107 into each signature 114 as is possible.

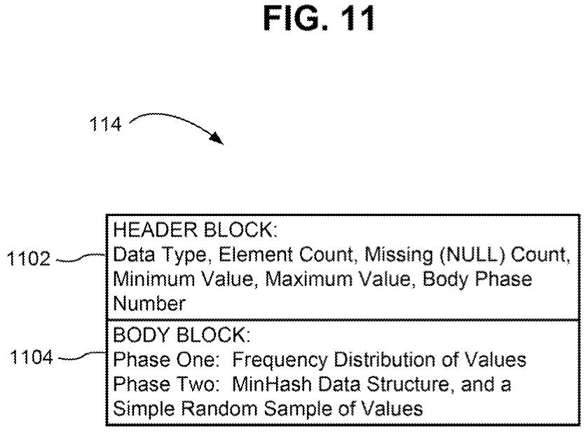

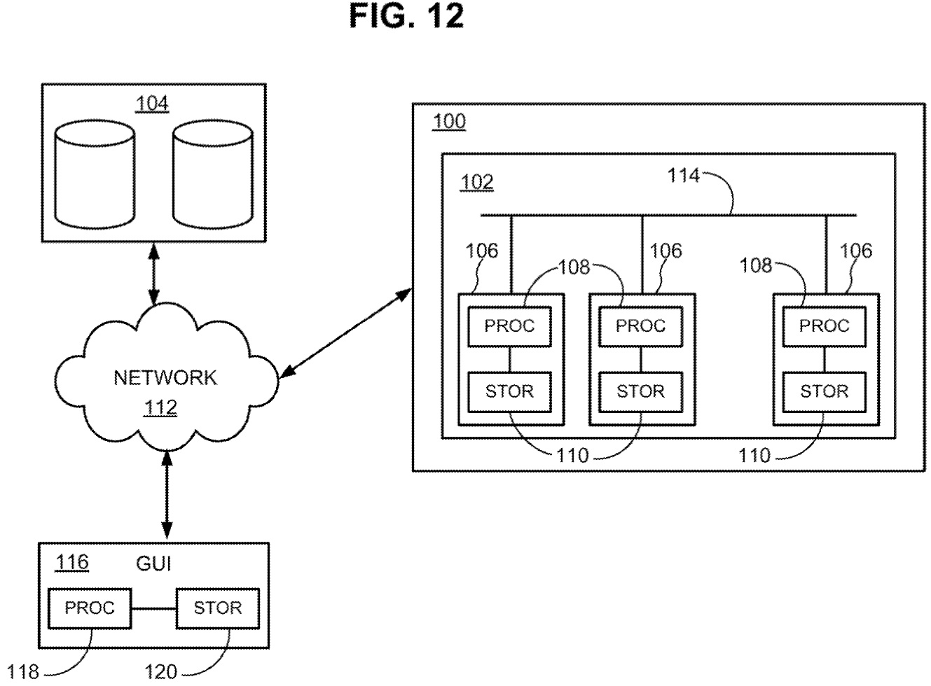

An example of a signature 114 is shown in FIG. 11. Recall that during survey operations (206), the data in each data element 107 is broken down into partitions and gather a per-partition survey before merging the per-partition signature data objects to arrive at an overall signature 114 for the entire data element 107. In creating the per-partition signatures, a signature data object 114 may be created at the time the survey (206) begins, which means memory is allocated for the signature 114 in each partition of the data of the data element 107. This can sometimes be a small number of tens of KB: for example, 48 KB. The header block 1100 of the signature 114 is typically a few tens of bytes and at initialization time is populated with the information about the data element 107 data type. This information is carried by each signature 114 through the survey (206) and mapping (208).

For each “value” (recall that a “value” may be a NULL token or some other kind of “missing information” reference), the survey (206) may:
1. Increments the “Element Count” of the header block 1100,
2. Checks to determine whether this “value” is a NULL or missing code, and if so, increments the Missing (NULL) Count.
3. Otherwise, checks to determine whether the “value” falls outside the Minimum Value to Maximum Value range, where necessary adjusting the range to include the new “value”.
4. If the signature 114 is operating in phase one (that is, if the Signature Body consists of a frequency distribution), attempt to update the Frequency Distribution either by locating this “value” and incrementing the count, or else by adding a previously unseen “value” to the data structure.
5. If the addition of the new “value” would result in a frequency distribution data structure that is too large (recall that all signatures 114 are restricted to some upper bound of memory), then convert the body block 1104 to Phase Two organization. If the new “value” fits into the Phase One organization, proceed to the next “value” from the data element.
6. The Phase Two organization of the signature body block 1104 has two components:
   a. A minHash data structure that can be used to estimate single data element 107 statistics such as cardinality, and pairwise relationships such as the size of an intersection. or the size of the union of the two.
   b. A simple random sample of the values in the data element 107 that can be used to estimate single data element statistics such as mean and median, as well as pairwise statistical relationships by comparing the two sample distributions.
      When the signature 114 is in Phase Two while the data element 107 is being surveyed (206), each additional “value” may update either the minHash structure, or the simple random sample, or neither (if the value has been seen before and the random sample algorithms does not require that it be recorded), or both.

Once all of the values in at least two partitions have been surveyed, the per-partition signature objects may be merged so as to produce a signature 114 that is the equivalent—for the purposes of estimating the statistical results needed by the map procedure 208—of one that would have been produced by surveying; all of the values in both partitions as a single signature result.

The approach to merging header blocks 1102 is straightforward and obvious. Merging the body block 1104 may be more involved, as it may require progress one, or the other, or both data structures through their phases. For example, in merging two signature objects S1 and S2:
If S1 and S2 are both in Phase 1 (are both frequency distributions) then we can proceed by taking each element (that is, each {value, count} pair) in the smaller of the two (say S1) and appending them to the Body Block of the larger (say S2). During this kind of merge, of course, the S2 Data Block may transition from Phase 1 to Phase 2.
If either S1 or S2 are in Phase 1 (say S1) but the other is not (say S2), then the approach is to take each {value, count} pair from the Phase 1 signature in S1 and append them to the Phase 2 data block in S2.
If both S1 and S2 are in Phase 2, then merging the minHash and the Simple Random Sample separately is needed. The procedure for merging minHash and samples is straightforward and well known in the art.

Starting with two partitions (that is, two non-overlapping subsets) of the data in a data element 107, which for example are DE₁ and DE₂, then the implementation of the signature survey (206) needs to guarantee that survey (DE₁∩DE₂) is equivalent to MERGE (SURVEY (DE₁), SURVEY (DE₂)) for the purposes of signature COMPARE to make the kinds of estimates we list below.

The kinds of comparisons we can make between the values in data elements 107 are estimates based on comparisons between per-data element signatures 114. The following table is a non-exhaustive list of functions that can be applied to a single signature 111 or pairs of signatures 114, passed as arguments.

TABLE 3
List of Functions and Comparisons Computable from the Signature Objects

| Function Name | Description |
|---|---|
| Signature_to_JSON | Given a signature type value, create a JSON text object that |
| | reports the information in it. |
| Population | Report the number of tokens that were found on the data |
| | element 107 and used to compile this signature 114. Note |
| | that this includes NULLS. |
| Null_Count | Report the number of NULL or missing tokens that were |
| | found on the data element 107. This means that the number |
| | of real values in the signature 1 14 is Population( ) − |
| | Null_Count( ). |
| IsSurrogate | Used to report when the signature data is a surrogate or |
| | synthetic key. Mechanically, this means (a) the type is |
| | integer, (b) the value range starts at 0 or 1, (c) the range of |
| | values between minValue and maxValues more or less |
| | accounts for every distinct value in the original data element |
| | 107. |
| Count_Estimate | Distinct count estimation for the number of tokens in the |
| | data element 107 used to compile the signature 114. |
| DC_Estimate_Method | Reports whether or not the signature sample is exact or |
| | approximate. That is, this function reports the signatures's |
| | 114 Phase (1 or 2). |
| Overlaps | Given two signatures 114 (of the same type), if they do not |
| | overlap (determined by their max and min values) then |
| | return a negative number. Otherwise return a positive |
| | number that reflects the kind of overlap. |
| P_XAGXB | Given two signature 114, what is the probability that a value |
| | x appears in the first signature 114, given that x appears in |
| | the second signature 114. |
| P_XBGXA | Given two signatures 114, what is the probability that a |
| | value x appears in the second signature, given that x appears |
| | in the first. |
| L0Dist | Given two signature s, create a pair of normalized |
| | histograms from the samples, and calculate the L0 distance |
| | between the normalized histograms. |
| L1Dist | Given two signature 114, create a pair of normalized |
| | histograms from the samples, and calculate the L1 distance |
| | between the normalized histograms. |
| L2Dist | Given two signatures 114, create a pair of normalized |
| | histograms from the samples, and calculate the L2 distance |
| | between the normalized histograms. |
| ChiSquare | Given two signatures 114, create a pair of normalized |
| | histograms from the samples, and calculate the Chi_Square |
| | distance between the distributions found in the normalized |
| | histograms. |
| Cosine | Given two signatures 114, create a pair of normalized |
| | histograms from the samples, and calculate the Cosine |
| | distance between the distributions found in the normalized |
| | histograms. |
| Pearson | Given two signatures 114, create a pair of normalized |
| | histograms from the samples, and calculate Pearson |
| | Correlation between the distributions found in the |
| | normalized histograms. |
| Kullback_Leibler | Given two signatures 114 which we will call S1 and S2, use |
| | the samples to create a pair of Probability Distribution |
| | Functions we will call P and Q and then compute the |
| | Kullback-Leibler divergence, which is an information |
| | theoretic measure that quantifies by how much one |
| | probability distribution differs from the other probability |
| | distribution. |
| Jensen_Shannon | Given two signatures 114 (S1 and S2) use the samples to |
| | create a pair of Probability Distribution Functions we will |
| | call P and Q and then compute the Jensen-Shannon |
| | divergence which is a symmetrized and smoothed version |
| | of the Kullback-Leibler divergence. Other statistical and |
| | information theoretic tests and distance/divergence methods |
| | can be added that will rely on the contents of the signatures |
| | 114. |

FIG. 12 is an example environment that allows the semantic mapping procedure to be implemented, The environment may include an analytic platform 100, such as a Teradata Vantage. In one example, the analytic platform 100 may include a relational database management system (RDBMS) 102 that implements a parallel-processing environment to carry out database management (as well as other analytic tools). The RDBMS 102 may be a combination of software (e.g., computer program routines, subroutines, applications, etc.) and hardware (e.g., processors, memory, etc.). In one example, the RDB MS 102 may be a massively parallel processing (MPP) system haying a number of processing units and distributed memory. In alternative examples, the RDBMS 102 may implement a single processing unit, such as in a symmetric multiprocessing (SMP) system configuration. The RDBMS 102 may include one or more processing units used to manage the storage, retrieval, and manipulation of data in data storage facilities (DSFs) 104. The DSFs 104 may be a persistent and/or non-persistent storage capable of storing structured and unstructured data. The processing units may include processing nodes 106 that manage the storage, retrieval, and manipulation of data included in a database.

In one example, each processing node 106 may include one or more physical processors 108 and memory 110. The memory 110 may include one or more memories and may be computer-readable storage media or memories, such as a cache, buffer, random access memory (RAM), removable media; hard drive, flash drive or other computer-readable storage media. Computer-readable storage media may include various types of volatile and nonvolatile storage media. Various processing techniques may be implemented by the processors 108 such as multiprocessing, multitasking, parallel processing, and the like, for example. The processing nodes 106 may include one or more other processing unit types such.

A network 112 may allow communication between the analytic platform 100 and the DSFs 104 so that data may be accessed by the analytic platform 100 stored in the DSFs 104. The network 112 may be wired, wireless, or some combination thereof. The network 112 may he a cloud-based, virtual private network, web-based, directly-connected, or some other suitable network configuration. In a cloud environment both the analytic platform 100 and DSFs may be distributed in the cloud allowing processing to be created or removed based on desired performance.

An interconnection 114 allows communication to occur within and between each processing node 106. For example, implementation of the interconnection 114 provides media within and between each processing; node 106 allowing communication among the various processing units. The interconnection 114 may be hardware, software, of some combination thereof. In instances of at least a partial-hardware implementation the interconnection 128, the hardware may exist separately from any hardware (e.g., processors, memory, physical wires, etc.) included in the processing nodes 106 or may use hardware common to the processing nodes 106. In instances of at least a partial-software implementation of the interconnection 114, the software may be stored and executed on one or more of the memories 110 and processors 108 of the processing nodes 106 or may be stored and executed on separate memories and processors that are in communication with the processing nodes 106.

A graphical user interface (GUI) 116 having a processor 118 and memory 120 may be used to interface with the analytic platform 100 and DSFs 104 via the network 112. The GUI 116 may allow the semantic mapping procedure 200 to be executed. In one example, the corpus 104 may reside in the DSFs 104 and the semantic mapping procedure 200 may be carried out in the analytic platform 100 using input from the GUI 116.

The examples herein have been provided with the context of a relational database system. However, all examples are applicable to various types of data stores, such as file systems or other data stores suitable for organization and processing of data, such as analytic platforms. While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A system comprising:
a storage device configured to persistently store a plurality of data elements;
a processor in communication with the storage device, the processor configured receive a data element;
identify contents of the data element;
create a data structure indicative of the contents of the data element; and
store the data structure in the storage device.

2. A method comprising:
receiving, with a processor, a data element;
identifying, with a processor, contents of the data element;
creating, with the processor, a data structure indicative, of the contents of the data. element; and
storing, with the processor, the data structure :in the storage device.

3. A computer-readable mediurn encoded with a plurality of instructions executable by the processor, the plurality of instructions comprising:
instructions to receive a data element;
instructions to identify contents of the data element;
instructions to create a data structure indicative of the contents of the data element; and
instructions to store the data structure in the storage device.
